(19) United States
(12) Patent Application Publication
(10) Pub. No.: US 2007/0264073 A1
(43) Pub. Date: Nov. 15, 2007

(54) Printer

(75) Inventors: Atsushi Hanada, Nishitokyo-shi (JP); Ryoji Hashizume, Kodaira-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TEAC Corporation, Tokyo (JP)

(21) Appl. No.: 11/800,328

(22) Filed: May 4, 2007

(30) Foreign Application Priority Data
May 12, 2006 (JP) 2006-133646

(51) Int. Cl. B41J 13/12

(52) U.S. Cl. 400/521

(57) ABSTRACT

An image is appropriately printed on a print target with at least a print area having a print surface and other areas connected to the print area at angles. A retention member for retaining the print target is formed from a disk tray, and an adapter removably attached to the disk tray. When an image is printed on a print target having a U-shaped cross-sectional profile, a recessed section on which the print area (an upper arm section) is to be placed is formed in an upper surface of the adapter. A lateral hole into which a lower arm—a non-print area—is to be inserted is formed in a side surface of the disk tray. In order to form a cutout space for accommodating a connection section which connects the upper arm with the lower arm, a cutout is formed in the side surface of the disk tray and in a side surface of the adapter, as well.

### PRIORITY INFORMATION

This application claims priority to Japanese Patent Application No. 2006-133646, filed on May 12, 2006, which is incorporated herein by reference in its entirety.

### BACKGROUND

1. Technical Field

The present invention relates to a printer for printing an image on a print surface set on an exterior surface of a print target corresponding to a recording medium or a constituent component thereof.

2. Related Art

A printer for printing an image on a non-recording surface of an optical disk serving as a recording medium; i.e., a so-called label surface, has hitherto been known. In such a printer, a disc-shaped optical disk is principally taken as an object to be printed (hereinafter called a “print target”), and the printer is equipped with a disk tray which supports the optical disk and transports the optical disk to a print execution position. A circular recessed section conforming to the shape of the optical disk is formed in the disk tray, and the optical disk is placed in that recessed section. A center hole of the optical disk is retained by means of retention means, such as an engagement pin or the like, thereby preventing occurrence of positional displacement of the optical disk.

In recent years, printers compatible with optical disks of shapes other than a circular shape; for example, essentially-rectangular optical disks or the like, have also been put forward. For example, JP 2002-260304 A describes the ability to subject optical disks of shapes other than a circular shape to printing by means of altering the shape of a recessed seat section formed in a print tray for accommodating a disk, to a rectangular shape, the shape of a heart, or a like shape, in conformance with the shape of an outer periphery of the disk.

However, according to the related art, only an optical disk; in other words, a plate-shaped recording medium, is taken as a print target, and no consideration is given to printing of an image on another recording medium; e.g., a non-plate-shaped recording medium. Meanwhile, a plurality of transportable recording mediums other than optical disks have recently been distributed into markets, and shapes of the mediums are diverse. For instance, the outer shape of a USB memory device is not defined by standards or the like, and hence USB memory devices of various shapes are circulated in markets. Among such recording mediums, some recording mediums have shapes which introduce a space between a print surface and a flat surface when a print target is placed on the flat surface with a print surface face up.

When such a recording medium is taken as a print target, a related-art print tray intended for taking only a plate-shaped recording medium as a print target cannot be used. Specifically, the related-art print tray intended for taking a plate-shaped substance as a print target is configured such that a print target is placed on a flat surface and such that the flat surface retains the print target. When the print target assumes the shape of a plate, such a simple configuration does not pose any problem. However, when a recording medium whose shape introduces a space between a print surface and a flat surface is taken as a print target, the print surface cannot contact the flat surface and, by extension, cannot be supported by the flat surface. Consequently, there arises a problem of the print surface undergoing warpage, or the like, under comparatively small pressure and failure to achieve appropriate printing of an image, under the influence of warpage.

### SUMMARY

Accordingly, the present invention provides a printer capable of appropriately printing an image on a print target of a shape which induces a space between a print surface and a flat surface when the print target is placed on the flat surface with the print surface face up.

The present invention provides a printer for printing an image on a print surface set in an exterior surface of a print target which is a recording medium or a component thereof, the printer comprising:

a retention member for retaining a print target of semi-hollow shape with at least a print area having a flat print surface and other areas connected to the print area at angles; and

a print mechanism for printing an image on the print surface of the print target retained by the retention member, wherein

the retention member has
a support section for supporting essentially the entire surface of the print area with the print surface exposed outside; and
an accommodation space for accommodating areas of the print target other than the print area.

In a preferred mode, the print mechanism applies pressure to the print surface during the course of printing operation. In this case, the printer preferably prints an image by means of thermal transfer printing.

In another preferred mode, the support section is a recessed section which is formed in an upper surface of the retention member and accommodates the print area. In this case, the recessed section preferably has the same outer peripheral shape as that of the print area.

In still another preferred mode, when the print target has a print area and a parallel area extending essentially parallel to the print area, the accommodation section includes an accommodation hole which is a lateral hole extending from a side surface of the retention member and which accommodates the parallel area. In yet another preferred mode, the accommodation section includes a space which is formed from a groove or a cutout formed in the retention member and accommodates the other areas.

In a further preferred mode, the retention member comprises a disk tray which is attached to a main body of the printer and which transports the print target to a print execution position; and an adapter which is removably attached to the disk tray and can be replaced in accordance with a shape of the print target.

According to the present invention, the retention member for retaining a print target comprises a support section for supporting a print area, and an accommodation space for accommodating areas other than the print area which hinder contact of the print area with a flat surface. Consequently, even when the print target assumes a semi-hollow shape, the entire surface of the print area is supported by the support section and becomes less susceptible to deflection even,when subjected to pressure. Therefore, appropriate printing of an image becomes feasible.

The invention will be more clearly comprehended by reference to the embodiment provided below. However, the scope of the invention is not limited to the embodiment.

### BRIEF DESCRIPTION OF THE DRAWINGS

A preferred embodiment of the present invention will be described in detail by reference to the following figures, wherein:

FIG. 1 is a perspective view of a printer which is an embodiment of the present invention;

FIG. 2 is a general schematic view of the printer;

FIG. 3A is a perspective view of USB memory not being used;

FIG. 3B is a perspective view of USB memory in use;

FIG. 3C is a general cross-sectional view of a cover body;

FIG. 4 is a view showing the manner of retaining a print target of semi-hollow shape;

FIG. 5 is an enlarged view of the principal section of a disk tray and that of an adapter;

FIG. 6A is a cross-sectional view taken along line A-A in FIG. 4;

FIG. 6B is a cross-sectional view taken along line B-B in FIG. 6A;

FIG. 7A is a view showing an adapter for use with a 12-cm CD;

FIG. 7B is a view showing an adapter for use with an 8-cm CD;

FIG. 7C is a view showing an adapter for use an essentially-rectangular CD;

FIG. 7D is a view showing an adapter for use with an essentially-rectangular magnetic card;

FIG. 8A is a perspective view of another print target of semi-hollow shape;

FIG. 8B is a general cross-sectional view of FIG. 8A;

FIG. 9 is a view showing an example disk tray and an example adapter which are appropriate for the print targets shown in FIGS. 8A and 8B;

FIG. 10A is a perspective view of another print target of semi-hollow shape as viewed from above;

FIG. 10B is a perspective view of the other print target of semi-hollow shape as viewed from below;

FIG. 11 is a view showing another example disk tray and another example adapter which are appropriate for a print target shown in FIGS. 10A and 10B; and

FIG. 12 is a view showing yet another example disk tray and yet another example adapter which are appropriate for a print target shown in FIGS. 10A and 10B.

### DETAILED DESCRIPTION

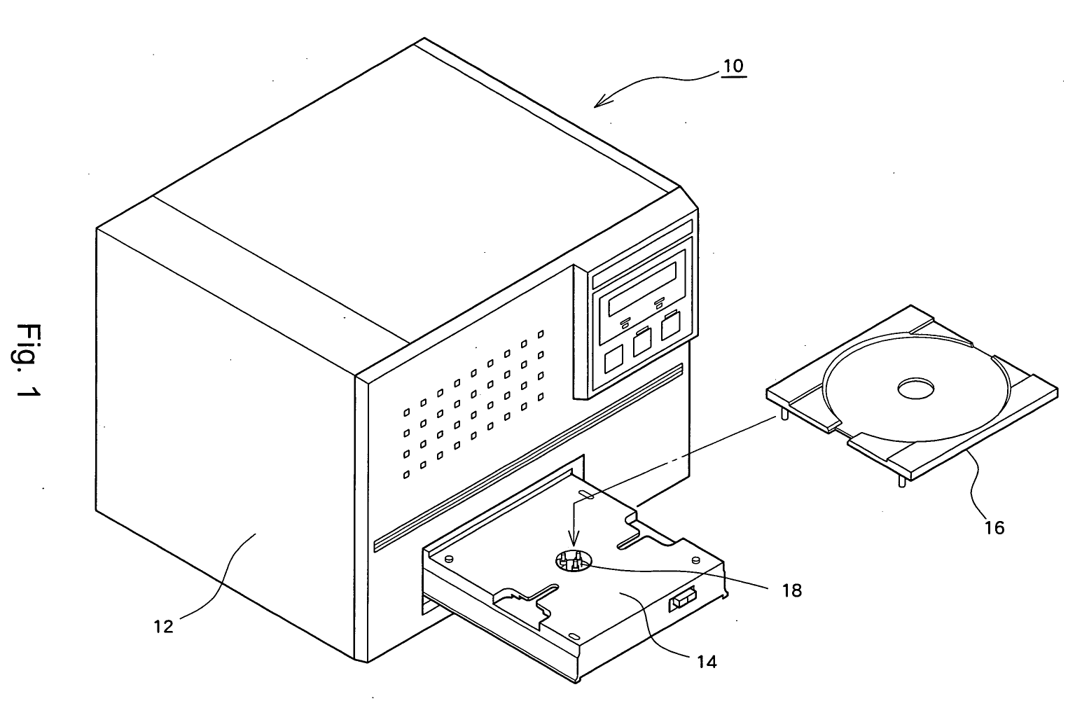

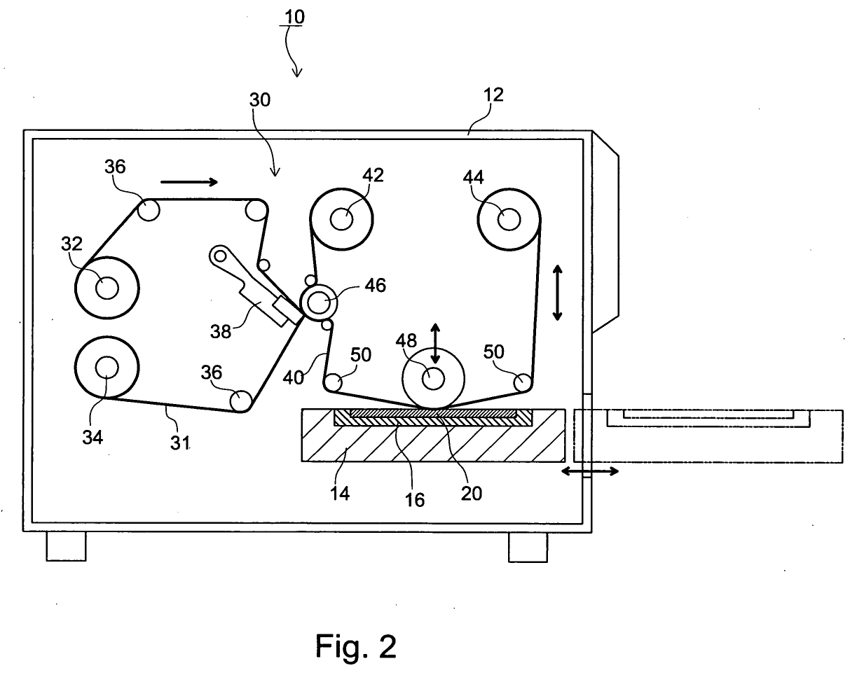

An embodiment of the present invention will be described hereunder by reference to the drawings. FIG. 1 is a perspective view of a printer 10 which is an embodiment of the present invention. FIG. 2 is a general schematic view of the printer 10. This printer 10 is an apparatus which prints an image on a print target corresponding to a recording medium or a constituent component of the recording medium. Data pertaining to a print image to be printed are transmitted from external information equipment (not shown) to the printer 10 by way of an interface cable, a network cable, or the like.

The printer 10 is equipped with a disk tray 14 which advances toward the outside of and recedes to the inside of a housing 12. This disk tray 14 works as retention means for retaining a print target 20, in synergistic cooperation with an adapter 16. The adapter 16 is a member which is removably attached to the disk tray 14, and a plurality of types of adapters are prepared according to the shape of the print target 20. A user alternatively selects the adapter 16 in conformity with the shape of the print target 20, and attaches the thus-selected adapter 16 to the disk tray 14. FIGS. 1 and 2 show, as an example of the adapter 16, an adapter used when the print target 20 is a 12-cm CD. Thus, using an adapter which is replaceable according to the shape of the print target 20 enables a single printer to handle print targets of various shapes, thereby enhancing the versatility of the printer. In association with movement of the disk tray 14, the print target 20 retained by the disk tray 14 and the adapter 16 is transported to a print execution position located within the housing 12.

A printing unit 30 for printing an image on the print surface of the print target 20 is provided in the housing 12. This printing unit 30 is a thermal-transfer printing unit which transfers ink of an ink ribbon 31 to an intermediate transfer sheet 40 and subsequently transfers the ink transferred to the intermediate transfer sheet 40 to a print surface of the print target 20. In the ink ribbon 30, ink of a plurality of colors; e.g., four colors, is repeatedly arranged on the ribbon in a longitudinal direction thereof. Ink to be pasted on the ink ribbon includes thermofusible ink and sublimation ink. Regardless of which type of ink is used, not much difference arises in the configuration of the printer 10 and transfer process. An explanation is now provided by reference to a case where thermofusible ink is used. This ink ribbon 31 is fed from a ribbon delivery bobbin 32, guided by a plurality of guide rollers 36, and sequentially taken up by a ribbon take-up bobbin 34. At an arbitrary position along the way of take-up of this ribbon, there is provided a thermal head 38 which brings the ink ribbon 31 into intimate contact with the intermediate transfer sheet 40 and fuses the ink on the surface of the ink ribbon 31. A plurality of heating elements (not shown) are provided in the thermal head 38. In accordance with a command from a control section, the thermal head 38 selectively heats the plurality of heating elements, thereby partially fusing the ink of the ink ribbon 31. The ink ribbon 31 whose ink is partially fused is pressed against the intermediate transfer sheet 40, whereupon fused ink is transferred to the intermediate transfer sheet 40.

The intermediate transfer sheet 40 is fed from a sheet feed bobbin 42, guided by a plurality of guide rollers 50, and taken up by a sheet take-up bobbin 44. A platen roller 46 which receives pressure from the thermal head 38 is provided at an arbitrary position along the way of take-up of the intermediate transfer sheet. As a result of the thermal head 38 pressing the ink ribbon 31 toward the platen roller 46, ink is transferred to the intermediate transfer sheet 40 fed along the platen roller 46.

As mentioned previously, ink of a plurality of colors is repeatedly arranged on the surface of the ink ribbon 31 in a longitudinal direction thereof. When a full-color image is printed, ink of a plurality of colors must have been transferred onto the intermediate transfer sheet 40 in advance. Accordingly, in the case of full-color printing, the intermediate transfer sheet 40 is taken up by the sheet feed bobbin 42 every time transfer of ink of one color affixed to the surface of the ink ribbon 31 is completed. The intermediate transfer sheet 40 is again taken up from the sheet feed bobbin 42 to the sheet take-up bobbin 44, whereby ink of the next color is transferred. Transfer of ink and take-up of the sheet are iterated by an amount corresponding to the number of colors of ink of the ink ribbon 31, whereby a full-color image is formed on the surface of the intermediate transfer sheet 40.

The full-color image formed on the intermediate transfer sheet 40 is transferred onto the print surface of the print target 20 by means of a transfer roller 48. The transfer roller 48 is a roller which has an internal heating element and can move up and down. During the course of transfer of ink from the ink ribbon 31 to the intermediate transfer sheet 40, this transfer roller 48 goes up to a position where the intermediate transfer sheet 40 does not contact the print surface. Meanwhile, when transfer of ink from the ink ribbon 31 to the intermediate transfer sheet 40 is completed and the full-color image is formed on the intermediate transfer sheet 40, the transfer roller 48 goes down, thereby pressing the intermediate transfer sheet 40 against the print surface of the print target 20. In this state, the transfer roller 48 and the print target 20 are moved at the same speed while the ink transferred onto the intermediate transfer sheet 40 is being fused by the heating element incorporated in the transfer roller 48. As a result, the full-color image formed on the intermediate transfer sheet 40 is transferred onto the print surface, whereby printing of the image is implemented.

When an image is transferred from the intermediate transfer sheet 40 to the print surface, great pressing force is exerted on the print surface. This is intended for bringing the intermediate transfer sheet 40 into intimate contact with the print surface without fail, and pressing force of 10 kilos to 40 kilos or there abouts is usually exerted. When warpage, or the like, has arisen in the print surface under the pressure, as a matter of course, appropriate transfer of an image cannot be realized. When warpage attributable to pressure has become excessively large, there may also arise a case where breakage of the print target 20 or the like occurs. For this reason, in order to perform appropriate printing of an image, the entire print surface must be reliably supported so as not to cause warpage in the print surface.

When the print target 20 is a plate-shaped recording medium such as a CD, a magnetic card, or the like, supporting of the entire print surface can be readily realized. Specifically, when the print target 20 assumes the shape of a plate, a flat surface on which the print target 20 can be placed has been formed in the disk tray 14 or the adapter 16 beforehand, and the print target 20 is placed on the flat surface such that the print surface faces up. Since the print surface is entirely supported by the flat surface provided in the disk tray 14 or the like, the print surface is not deflected even when subjected to great pressing force exerted by the transfer roller 48, and appropriate printing of an image can be implemented.

However, when the print target assumes a non-plate shape, printing of an image cannot be performed by means of only the above technique. For instance, consideration is given to a case where an image is printed on a USB memory or a constituent component thereof. As is well known, the USB memory is a recording medium which has a built-in flash memory and can exchange data by way of a USB. In this USB memory, the dimension of a terminal portion of the USB is specified. However, dimensions of other portions are not specified. For these reasons, USB memory devices of various shapes are currently circulated in the market.

In some of these USB memory devices, the entire USB memory or a partial constituent element assumes a semi-hollow shape. Here, the semi-hollow shape corresponds to a three-dimensional shape where two or more parts are connected together at angles. For instance, shapes such as the shape of a box whose bottom is open, a shape having a U-shaped cross-sectional profile, a C-shaped cross-sectional profile, an L-shaped cross-sectional profile, a Z-shaped cross-sectional profile, an E-shaped cross-sectional profile, or the like, correspond to the semi-hollow shape.

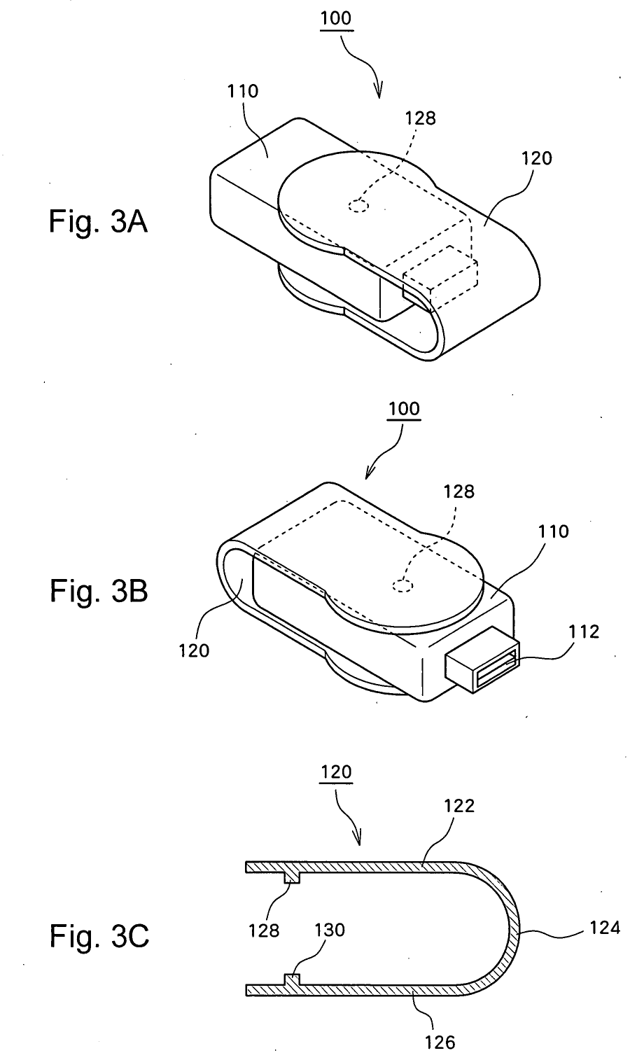

FIG. 3 is a view showing an example of USB memory 100 formed from the main body 110 and a cover body 120 of semi-hollow shape. FIG. 3A shows the state of the USB memory 100 not being used. FIG. 3B is a view showing the state of the USB memory 100 in use, and FIG. 3C is a cross-sectional profile of the cover body 120.

This USB memory 100 is coarsely divided into the main body 110 having an USB terminal 112 provided at an extremity thereof, and the cover body 120 for protecting the USB terminal 112. The cover body 120 comprises a pair of arm sections 122, 126 mutually opposing each other with the main body 110 sandwiched there between, and a semicircular connection section 124 for connecting the pair of arm sections 122 and 126; and assumes a semi-hollow shape having a U-shaped cross-sectional profile. This cover body 120 can pivot, with respect to the main body 110, around an upper pivot 128 provided on a bottom surface of the upper arm section 122 in a protruding manner and a lower pivot 130 provided on the upper surface of the lower arm section 126 in a protruding manner. When the USB memory 100 is not used, the cover body 120 is pivoted with respect to the main body 110, to thus place the connection section 124 of the cover body 120 at a position in front of the USB terminal 112 to protect the terminal 112 from dust and external pressure. Meanwhile, when the USB memory 100 is used, the cover body 120 is pivoted with respect to the main body 110, to thus move the connection section 124 from the position in front of the USB terminal 112 and make the USB terminal exposed to the outside.

Consideration is given to a case where an image is printed on the surface of the cover body 120 of such USB memory 100. Specifically, consideration is given to a case where the upper surface of the upper arm section 122 of the cover body 120 is taken as a print surface. In this case, the cover body 120 is removed from the main body 110 of the USB memory 100, and only the cover body 120 is subjected to print processing while being mounted on the printer. At this time, the print surface (i.e., the upper surface of the upper arm section 122) cannot be supported appropriately only by means of placing the cover body 120 on the flat surface of the disk tray 14 or the adapter 16. Specifically, as is evident from FIG. 3C, the cover body 120 assumes a U-shaped cross-sectional profile, and a space exists between the upper arm section 122 having a print surface and the lower arm section 126 to be placed on the disk tray or the like. Put another way, when the cover body 120 is placed merely on the flat surface, the upper arm section 122 with the print surface set there on remains in the state of a cantilever and becomes deflected by means of comparatively-small pressing force. Consequently, warpage is caused by the pressing force exerted by the transfer roller 48 during printing of an image, which in turn results in an image transfer failure, infliction of damage to the cover body 120, or the like.

Pad printing and laser marking printing have hitherto been known as printing techniques for enabling printing of an image even on a three-dimensional substance such as the cover body 120. According to these printing techniques, a print surface is not pressed during the course of printing of an image. Therefore, pad printing and laser marking printing enable printing of an image on even a print target of semi-hollow substance. However, pad printing is a printing method which uses a soft pad made of silicon rubber as a print medium, and laser marking printing is a printing method for exposing the print target to marking laser to create an image. Each of these techniques requires a piece of custom-designed printing apparatus. Therefore, special technical knowledge is also required to handle these pieces of custom-designed printing apparatus, and the apparatus is not appropriate as a general-purpose printer handled by an individual. Moreover, the apparatus is not compatible with the printing method adopted for printing an image on a label of a plate-shaped recording medium such as an optical disk, a magnetic card, and others, and hence difficulty is encountered in establishing the apparatus as a multifunctional printer.

Accordingly, in the present embodiment, the shape of the disk tray 14 and that of the adapter 16 are made special in order to enable appropriate retention of a print target of such a semi-hollow shape and easy, appropriate printing and combination of a printer for printing an image on a label of a plate-shaped recording medium. The disk tray 14 and the adapter 16 of this printer 10 will be described in detail here under.

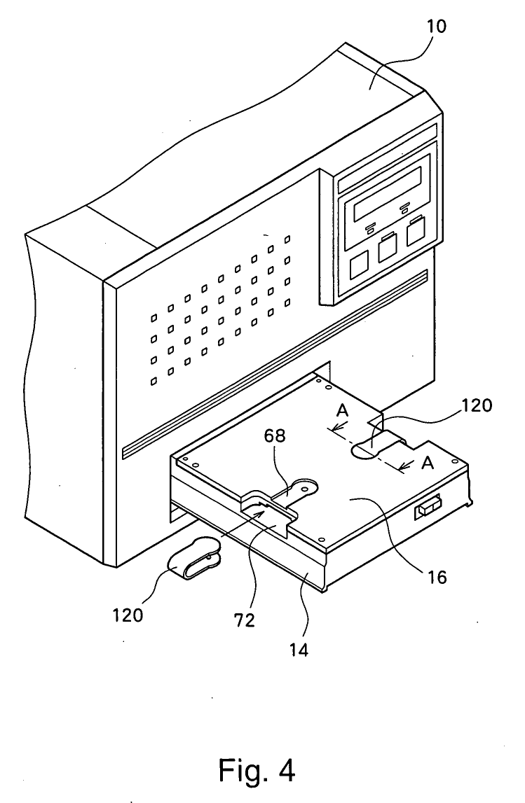

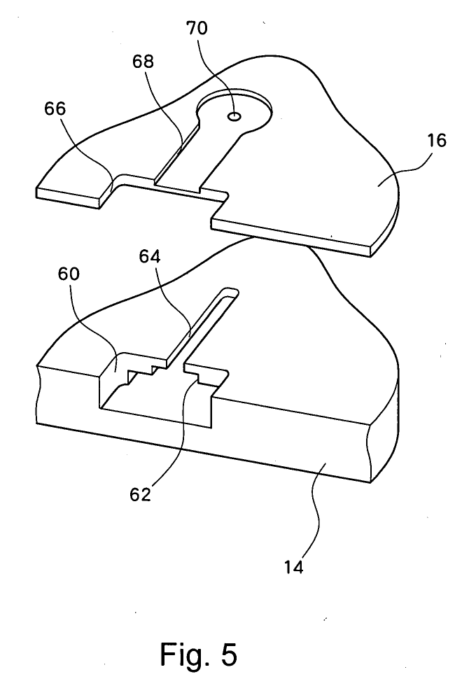

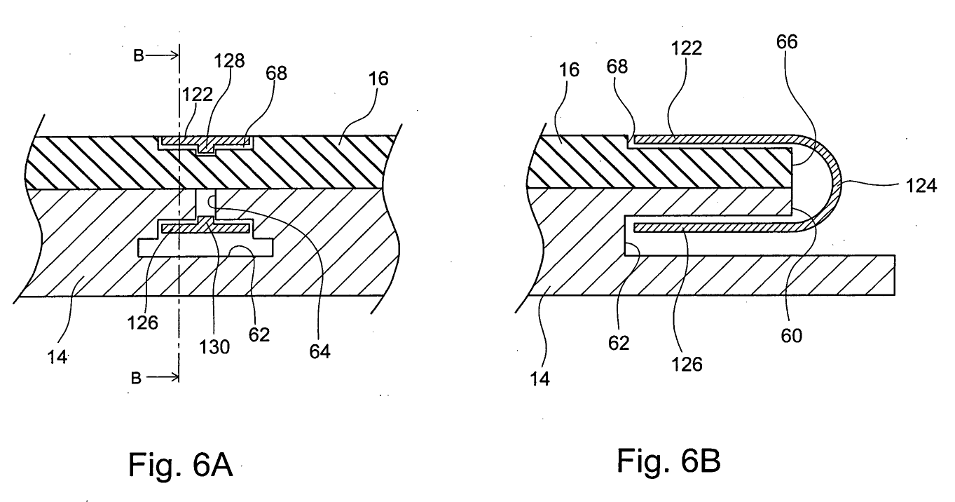

FIG. 4 is a view showing a state where an image is printed on the previously-described cover body 120 having a U-shaped cross-section profile. FIG. 5 is an enlarged view of the principle section of the disk tray 14 and that of the adapter 16. FIG. 6A is a cross-sectional view taken along line A-A shown in FIG. 4, and FIG. 6B is a cross-sectional view taken along line B-B shown in FIG. 6A. In FIGS. 6A and 6B, a clearance is illustrated between the adapter 16 and the cover body 120 for ease of view. However, in reality, no substantial clearance exists between them.

An essentially-rectangular tray-side cutout section 60 is formed in a side surface of the disk tray 14. In synergistic corporation with an adapter-side cutout section 66 formed in the adapter 16 to be described later, the tray-side cutout section 60 forms a cutout space 72 which accommodates the connection section 124 of the cover body 120. Therefore, the tray-side cutout section 60 is approximately of a size which enables accommodation of the connection section 124.

An accommodation hole 62, which is a lateral hole extending toward the inside of the disk tray 14 in a width wise direction thereof, is formed in an end face of the tray-side cutout section 60. During printing of an image, the lower arm section 126 of the cover body 120 is inserted and accommodated into this accommodation hole 62. Consequently, this accommodation hole 62 is greater in width than the lower arm section 126, and has a depth greater than the length of the lower arm section 126.

A slit 64 extending in the longitudinal direction of the accommodation hole 62 is formed in line with the center line of the accommodation hole 62. The slit 64 has a width which is slightly larger than the diameter of the lower pivot 130. When the lower arm section 126 is inserted into the accommodation hole 62, the lower pivot 130 fits into the slit 64 and moves along the slit 64. Specifically, the slit 64 acts as a release groove for releasing the lower pivot 130 at the time of insertion of the lower arm section 126, as well as serving as a guide groove for guiding the direction of movement of the lower pivot 130 and, by extension, the direction of insertion of the cover body 120.

The adapter-side cutout section 66 whose outer peripheral shape is the same as that of the tray-side cutout side section 60 is formed in the side surface of the adapter 16, as well. This adapter-side cutout section 66 is formed at a position corresponding to the tray-side cutout section 60. When the adapter 16 is attached to the disk tray 14, the adapter-side cutout section 66 forms the cutout space 72 which accommodate the connection section 124 of the cover body 120, in synergistic cooperation with the tray-side cutout section 60. This cutout space 72 and the accommodation hole 62 act as accommodation spaces for accommodating areas (the connection section 124 and the lower arm section 126) other than a print area (the upper arm section 122) having a print surface.

Moreover, a recessed section 68 which accommodates the upper arm section 122 of the cover body 120 is formed at a position of the adapter 16 corresponding to the accommodation hole 62 of the disk tray 14. This recessed section 68 has the same outer peripheral shape as that of the upper arm section 122. When the recessed section 68 is placed on the upper arm section 122, movement of the upper arm section 122 is regulated by means of a brim of the recessed section 68 and the upper arm section 122 is positionally fixed. Further, the depth of the recessed section 68 is such that the height of an upper surface (a print surface) of the upper arm section 122 placed in the recessed section 68 becomes equal to the height of a print execution section. In the recessed section 68, a bearing hole 70 for receiving an upper rotation shaft 128 of the cover body 120 is formed at a position corresponding to the upper rotation shaft 128. As a result of the upper rotation shaft 128 fitting into this bearing hole 70, the bottom of the upper arm section 122 forming a flat surface fully contacts an upper surface of the recessed section 68 forming a flat surface. Consequently, the upper arm section 122 is completely supported by the recessed section 68. In short, this recessed section 68 acts as a support section for completely supporting the print area (i.e., the upper arm section 122) with the print surface exposed outside.

Next will be described briefly flow of processing performed when the cover body 122, or the print target, is retained by means of that adapter 16 and that disk tray 14. In this case, the user sets the adapter 16 on the disk tray 14 in advance. Subsequently, the lower arm section 126 is inserted into the accommodation hole 62 with the upper arm section 122 being exposed on the recessed section 68. The entire cover body 120 is pushed deep into the back in this state. At this time, the advancing direction of the cover body 120 is guided by the slit 64 having received the lower pivot 130. Finally, the cover body 120 is moved to a position where the upper pivot 128 fits into the bearing hole 70 formed in the recessed section 68.

At that time, the upper arm section 122 is completely supported by the recessed section 68. Therefore, even when being pressed by the transfer roller 48, the upper arm section 122 is not deflected, and superior printing of an image becomes feasible.

As is evident from the above description, in the present embodiment, printing of an image on a print target of a semi-hollow shape; in other words, a three-dimensional shape, is enabled, and hence means for retaining the print target; namely, the disk tray 14 and the adapter 16, also assume three-dimensional shapes. Specifically, the retention means forms a support section for supporting a print area of a print target and an accommodation space for accommodating other areas extending in planes differing from the print area. As a result, an image can be appropriately printed on a print target of three-dimensional shape.

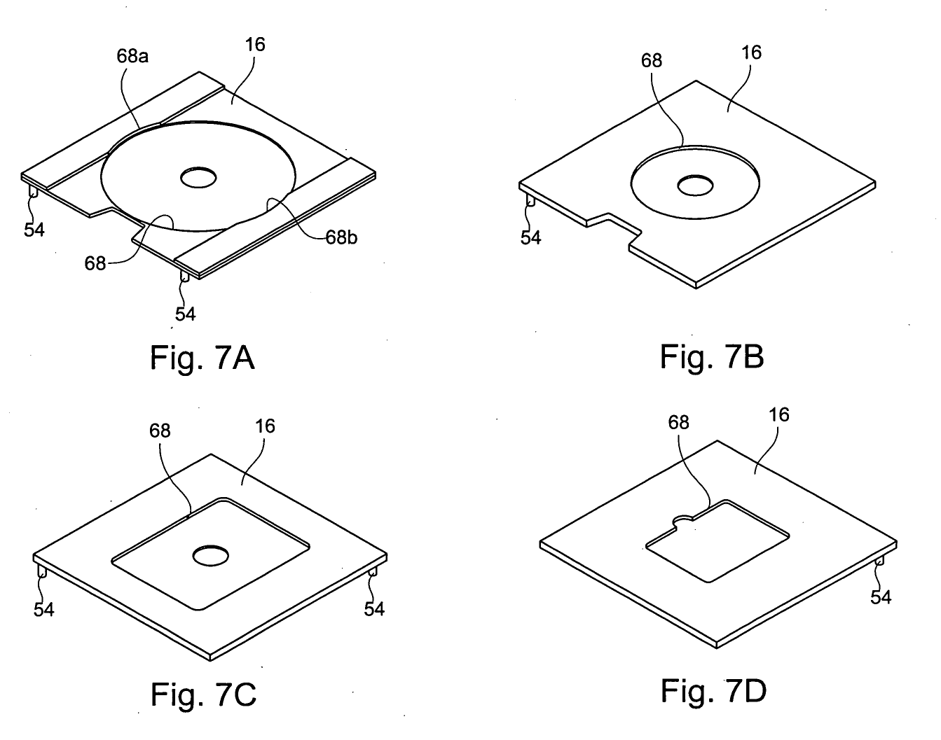

As a matter of course, replacement of the adapter enables the printer 10 of the present embodiment to print an image on a print target of another shape. FIG. 7 illustrates an example of the adapter 16 used in this case. FIG. 7A shows an adapter 16 for use with a 12-cm CD; FIG. 7B shows an adapter 16 for use with an 8-cm CD; FIG. 7C shows an adapter 16 for use with an essentially-rectangular CD; and FIG. 7D shows an adapter 16 for use with an essentially-rectangular magnetic card. Any of these adapters take plate-shaped recording mediums as print targets. The essential requirement is to form the recessed section 68 having the same outer peripheral shape as that of the print target in the adapter 16 that takes such a plate-shaped recording medium as a print target. When a protective sheet for protecting a recording surface of an optical disk is affixed to the recessed section 68, the recessed section 68 is set in consideration of the thickness of the protective sheet. The recessed section 68 does not necessarily assume a shape for supporting the entire outer periphery of the print target. As shown in FIG. 7A, the recessed section 68 may also assume shapes 68a, 68b which support portions of the outer periphery of the print target. For instance, in the case of the adapter 16 such as that shown in FIG. 7A, when a protective sheet is affixed to the recessed section 68, the print target is supported by the support sections 68a, 68b. So long as the print target is placed on the recessed section 68 of the adapter 16 with the adapter 16 being set on the disk tray 14, the entire surface of the plate-shaped print target is supported by the adapter 16.

In detail, in the present embodiment, the retention means for retaining a print target is formed from the disk tray 14 and the adapter 16 that is removably attached to the disk tray 14, and the adapter 16 is made replaceable in accordance with the shape of the print target. As a result, the single printer 10 enables handling of print targets of various shapes, so that the versatility of the printer 10 can be enhanced. Further, a print target having a center hole, such as an optical disk, is engaged with a plurality of engagement pins 18 (see FIG. 1) provided on the disk tray 14 or the like (i.e., an interior wall of the center hole is pressed by the plurality of engagement pins 18), whereby the print target can be retained more reliably.

When the adapter 16 is replaced, as required, in accordance with the shape of such a print target, provision of determination means for determining the type of an adapter attached to the disk tray 14 is desirable. For instance, pivots 54, which differ from each other in terms of projecting positions and number according to the types of adapters, are formed on the bottom of each of the adapters 16, and the disk tray 14 is provided with a sensor for detecting the number and position of the pivots 54. The control section of the printer 10 determines the type of the adapter 16 from a result of determination performed by the sensor. The thus-acquired result of determination pertaining to the type of the adapter is preferably utilized for selecting print image data, or the like.

The above description mentions only the cover body 120 having a U-shaped cross-sectional profile as an example print target of semi-hollow shape. However, as a result of the shape of the adapter 16 and the shape of the disk tray 14 being changed appropriately, the present invention can also be naturally applied to a print target of another semi-hollow shape.

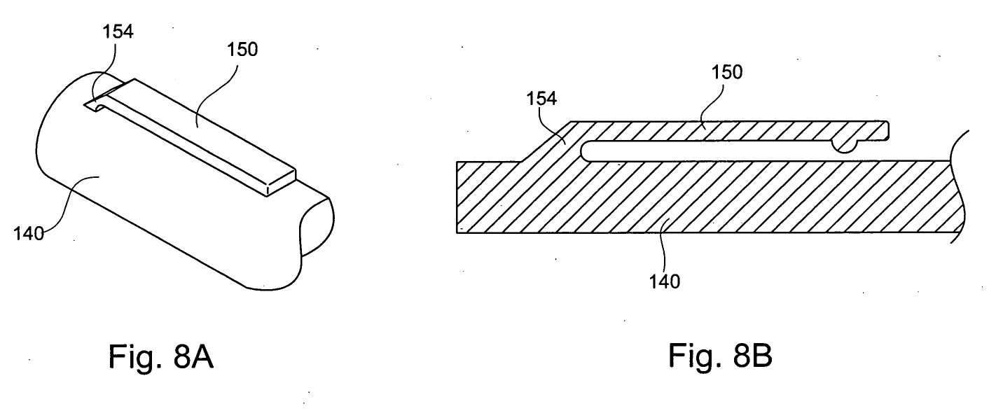

For instance, consideration is given to a case where an image is printed on an upper surface of a clip body 150 attached to the side surface of a main body 140 such as that shown in FIG. 8. The clip body 150 is an essentially-plate-shaped member and disposed opposite the main body section 140 with a nominal gap there between. This clip body 150 is connected to the main body 140 by means of a connection section 154 connected to the clip body 150 at an angle. When an image is printed on the surface of the clip body 150, the recording medium must be retained with the entirety of the clip body 150 being supported.

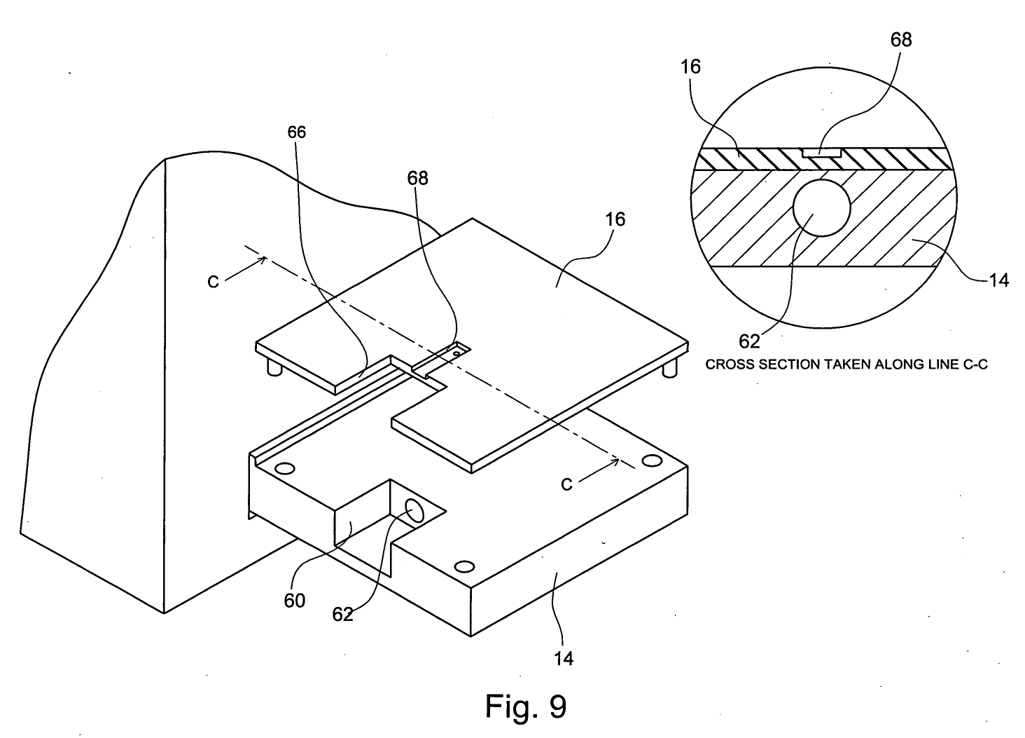

When such a recording medium is taken as a print target, the disk tray 14 and the adapter 16, such as those shown in FIG. 9, are used. The tray-side cutout section 60 is formed in a side surface of the disk tray 14, and a lateral hole for accommodating the main body 140 is formed as the accommodation hole 62 in an end face of the tray-side cutout section 60. Moreover, an adapter-side cutout section 66 forming a cutout space in synergistic cooperation with the tray-side cutout section 60 and the recessed section 68 for accommodating the clip body 150 are formed in the adapter 16.

When an image is printed, this adapter 16 is placed on the disk tray 14 in advance. The main body 140 is inserted into the accommodation hole 62 with the clip body 150 facing up with respect to the recessed section 68. Finally, the main body 140 is pushed into a position where the clip body 150 is fully accommodated into the recessed section 68. At this time, a portion of the main body 140 and the connection section 154, which have not been completely accommodated into the accommodation hole 162, are accommodated into the cutout space and do not hinder printing of the image. The entire surface of the clip body 150 is supported by the recessed section 68 and is not deflected when being pressed by the transfer roller 48, and appropriate printing of an image can be implemented.

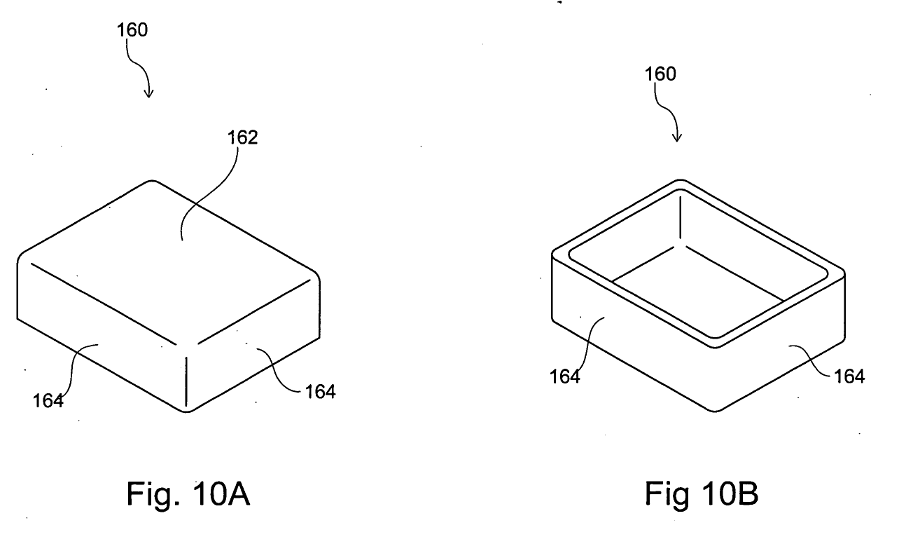

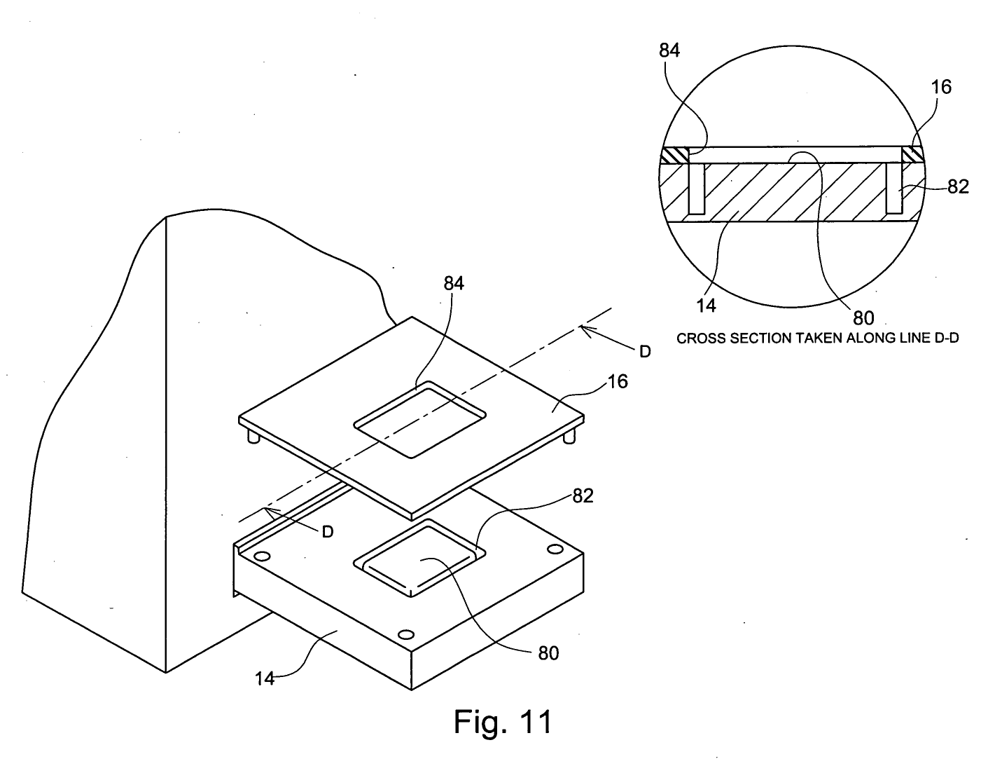

In any of the above descriptions, the lateral hole formed in the side surface of the disk tray 14 is taken as the accommodation hole 62. However, another accommodation hole 62 of a different size may also be provided at a different location according to the shape of the print target. For instance, consideration is given to a case where an essentially-box-shaped body 160 having an open bottom, such as that shown in FIG. 10, is taken as a print target and where an upper surface 162 of the box-shaped body 160 is taken as a print surface. FIG. 11 shows an example disk tray 14 and an example adapter 16 which are appropriate for this case. An accommodation groove 82 for accommodating a sidewall 164 of the box-shaped body 160 is formed in the upper surface of the disk tray 14. Of the upper surface of the disk tray 14, an area surrounded by the accommodation groove 82 acts as a support surface 80 for supporting the upper surface 162 of the box-shaped body 160 that forms the print surface. A through hole 84 having the same outer peripheral shape as that of the box-shaped body 160 is formed in the adapter 16. Movement of the box-shaped body 160 attached to the disk tray 14 is regulated by the brim of this through hole 84, whereby the box-shaped body 160 is positionally fixed.

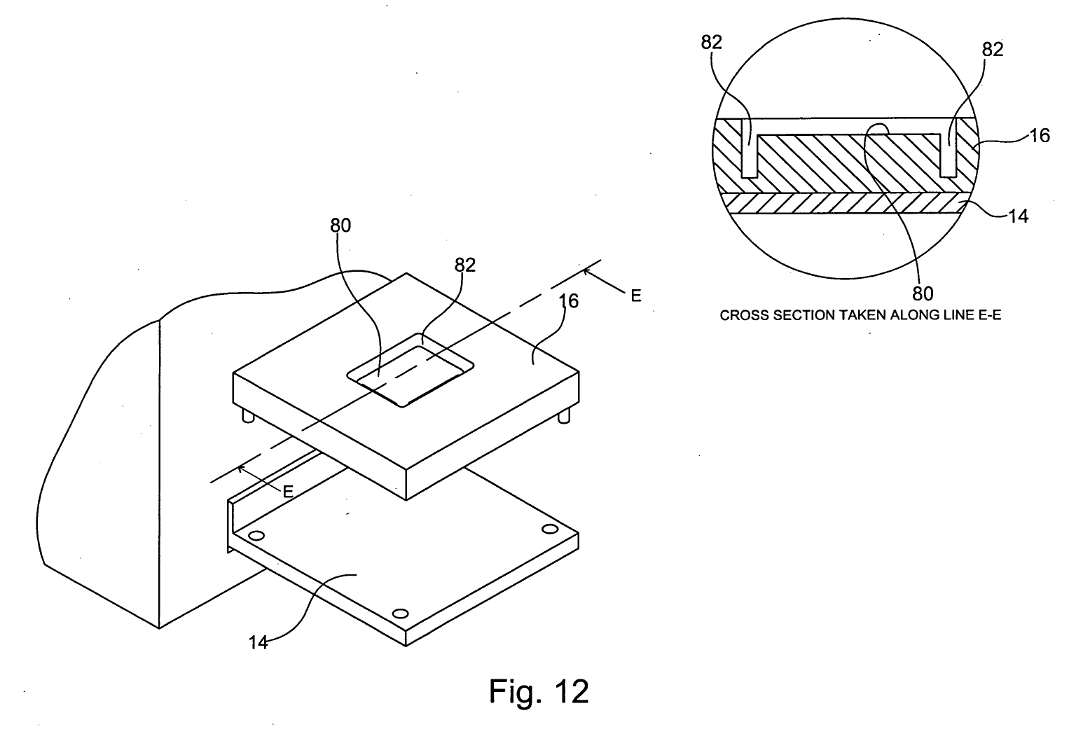

In any of the above descriptions, the accommodation space is formed by means of synergistic cooperation of the adapter 16 with the disk tray 14. However, as shown in FIG. 12, the thickness of the adapter 16 may be increased, and the print target may be retained solely by the adapter 16. FIG. 12 shows an example adapter appropriate for retaining a print medium made of the box-shaped body 160 shown in FIG. 10. The thickness of this adapter 16 is greater than the height of the box-shaped body 160. The accommodation groove 82 for accommodating the sidewall 164 of the box-shaped body 160 is formed in the surface of the adapter 16. The support surface 80 for supporting the upper surface 162 of the box-shaped body 160 is formed inside of this housing groove 82. With such a configuration for making the thickness of the adapter 16 large and retaining the print target by means of only the adapter 16, the necessity for imparting a special shape to the disk tray 14 attached to the apparatus is obviated, and versatility of the printer 10 can be enhanced further. Conversely, as a matter of course, there may also be adopted a configuration for retaining a print target by means of only the disk tray 14 without use of the adapter. Specifically, the disk tray may be provided with a support surface for supporting a print area, and an accommodation space for accommodating areas other than the print area.

Furthermore, so long as a print target is a substance of semi-hollow shape with a print area having a flat print surface and other areas connected to the print area at angles, a recording medium or a constituent component thereof may also be taken as the print target.

What is claimed is:

1. A printer for printing an image on a print surface set in an exterior surface of a print target which is a recording medium or a component thereof, the printer comprising:
a retention member for retaining a print target of semi-hollow shape with at least a print area having a flat print surface and other areas connected to the print area at angles; and
a print mechanism for printing an image on the print surface of the print target retained by the retention member, wherein the retention member has
a support section for supporting essentially the total surface of the print area with the print surface exposed outside; and
an accommodation space for accommodating areas of the print target other than the print area.

2. The printer according to claim 1, wherein the print mechanism applies pressure to the print surface during the course of printing operation.

3. The printer according to claim 2, wherein the print mechanism prints an image by means of thermal transfer printing.

4. The printer according to claim 1, wherein the support section is a recessed section which is formed in an upper surface of the retention member and accommodates the print area.

5. The printer according to claim 4, wherein the recessed section has the same outer peripheral shape as that of the print area.

6. The printer according to claim 1, wherein, when the print target has a print area and a parallel area extending essentially parallel to the print area, the accommodation section includes an accommodation hole which is a lateral hole extending from a side surface of the retention member and which accommodates the parallel area.

7. The printer according to claim 1, wherein the accommodation section includes a space which is formed from a groove or a cutout formed in the retention member and accommodates the other areas.

8. The printer according to claim 1, wherein the retention member comprises
a disk tray which is attached to a main body of the printer and which transports the print target to a print execution position; and
an adapter which is removably attached to the disk tray and can be replaced in accordance with a shape of the print target.

9. A printer for printing an image on a print surface set in an exterior surface of a print target, the printer comprising:
a retention member for retaining a print target of semi-hollow shape with at least a print area having a flat print surface and other areas connected to the print area at angles; and
a print mechanism for printing an image on the print surface of the print target retained by the retention member, wherein
the retention member has
a support section for supporting essentially the entire surface of the print area with the print surface exposed outside; and
an accommodation space for accommodating areas of the print target other than the print area.
